(19) United States
(12) Patent Application Publication
(10) Pub. No.: US 2013/0041916 A1
(43) Pub. Date: Feb. 14, 2013

(54) PRESENTATION OF SOCIAL GRAPH DATA

(71) Applicants: Blake Biesecker, Portland, OR (US); Kerry Kelley, Portland, OR (US)

(72) Inventors: Blake Biesecker, Portland, OR (US); Kerry Kelley, Portland, OR (US)

(73) Assignee: HomeAway.com, Inc., Austin, TX (US)

(21) Appl. No.: 13/230,759

(22) Filed: Sep. 12, 2011

Related U.S. Application Data
(60) Provisional application No. 61/522,668, filed on Aug. 11, 2011.

(51) Int. Cl. G06F 17/30

(52) U.S. Cl. 707/769; 707/E17.011

(57) ABSTRACT

Presentation of social graph data is described, including techniques for displaying connection information comprising receiving a login identifying a member, retrieving from a database an item to which the member is connected, and displaying the item and a connection between the item and the member. Embodiments of the invention include obtaining social data from a social networking service, and using the social data to update social graphs.

### CROSS REFERENCE TO RELATED APPLICATIONS

This application is a U.S. non-provisional patent application that claims the benefit of U.S. Provisional Patent Application No. 61/522,668, filed Aug. 11, 2011, and entitled “Presentation of Social Graph Data,” which is herein incorporated by reference for all purposes.

### FIELD

The present invention relates generally to software and electronic commerce. More specifically, techniques associated with presentation of social graph data are described.

### BACKGROUND

Consumers consult many sources of information when searching for items of interest to rent or buy, including the vast Internet. However, the majority of consumers still trust recommendations from people they know and opinions (e.g., reviews, ratings, comments, etc.) by others with common attributes (e.g., place of residence, place of vacation, group affiliations, hobbies, etc.) over all other types of information to help them make decisions with regard to high risk transactions (e.g., involving large dollar amounts). A person's social networks (e.g., networks maintained on social or professional networking websites) can be used to rapidly grow both demand and supply for the rental or sale of an item, particularly a high-priced item, by reducing the fear and hassle of dealing with strangers.

Conventional electronic commerce techniques for marketing and promotion of items for rent or sale typically include a listing of the item, e.g., on a marketing or promotion website, with information about the item. Such information may include features and photos of the item. For instance, a vacation rental listing may include information about the vacation rental property's size (e.g., bedrooms, bathrooms, square footage, etc.) and location (e.g., street address, nearby landmarks, etc.). The listing may include photos of the property, inside and out. The listing may even include reviews of the property by past guests. However, these conventional techniques for marketing and promotion of items for rent or sale do not provide a direct and organized method for a user to find information about the items that are owned by, used by, rented by, reviewed by, or otherwise connected to, people in their social networks. While reviews from strangers may be helpful, they are not nearly as helpful as reviews from people users know (e.g., family members, friends, co-workers, acquaintances, etc.). These conventional techniques fail to leverage the power of a consumer's social networks, particularly social networks created and maintained on social or professional networking services and websites (hereinafter “SNS”), to more effectively market items for rent or sale.

On the other hand, SNS, including Facebook®, Twitter®, Google+®, Linkedln®, and others, provide a venue for users to maintain their social networks and share information about items they've purchased or rented, and even post reviews. However, these services are geared primarily toward the creation and maintenance of social networks, and are not designed to provide users with the capability to search for and find trusted and vetted listings of items for sale or rent. For instance, when an SNS user posts a status update, link, picture, or tweet, indicating a purchase or rental (e.g., vacation rental), even including a review or comment about the item purchased or rented, that status update, link, picture or tweet is virtually lost as time passes and new status updates, links, pictures and tweets are posted. Later on, when another user that is in their network begins searching for a similar item to purchase or rent, it is difficult, if not impossible, to directly reference the prior post. As such, SNS do not offer owners and sellers the ability to create a standing and readily searchable referral network for items for rent or sale based upon personal data shared through SNS, nor do they provide renters and buyers a time independent method for searching for items to buy or rent using their trusted personal connections.

Thus, what is needed is a technique for marketing of items for rent or sale without the limitations of conventional techniques.

### BRIEF DESCRIPTION OF THE DRAWINGS

Various embodiments or examples of the invention are disclosed in the following detailed description and the accompanying drawings:

FIG. 1 illustrates an exemplary system for creating, storing and using social graphs for marketing items for sale or rent;

FIGS. 2A-2C illustrate exemplary processes for retrieving and displaying connection information associated with an item using a social graph;

FIG. 3 illustrates an exemplary table for storing connection information in a social graph associated with an item for rent or sale;

FIG. 4 illustrates an alternative exemplary table for storing connection information in a social graph associated with an item for rent or sale;

FIG. 5 illustrates an exemplary representation of a social graph for an item for rent or sale;

FIG. 6 illustrates an exemplary wireframe of an exemplary marketing webpage providing search and display capabilities associated with a database of social graphs;

FIG. 7 illustrates an alternative exemplary wireframe of an exemplary marketing webpage providing search and display capabilities associated with a database of social graphs; and

FIG. 8 illustrates an exemplary computer system suitable for creating, storing and using social graphs for marketing items for rent or sale.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including Java™, Javascript™, Ruby, Rails, C, Objective C, C++, C#, Adobe® Integrated Runtime™ (Adobe® AIR™), ActionScript™, Flex™, Lingo™, Ajax, Perl, COBOL, Fortran, ADA, XML, MXML, HTML, DFITML, XFITML, HTTP, XMPP, and others. Design, publishing, and other types of applications such as Dreamweaver®, Shockwave®, Flash®, and Fireworks® may also be used to implement the described techniques. The described techniques may be varied and are not limited to the examples or descriptions provided.

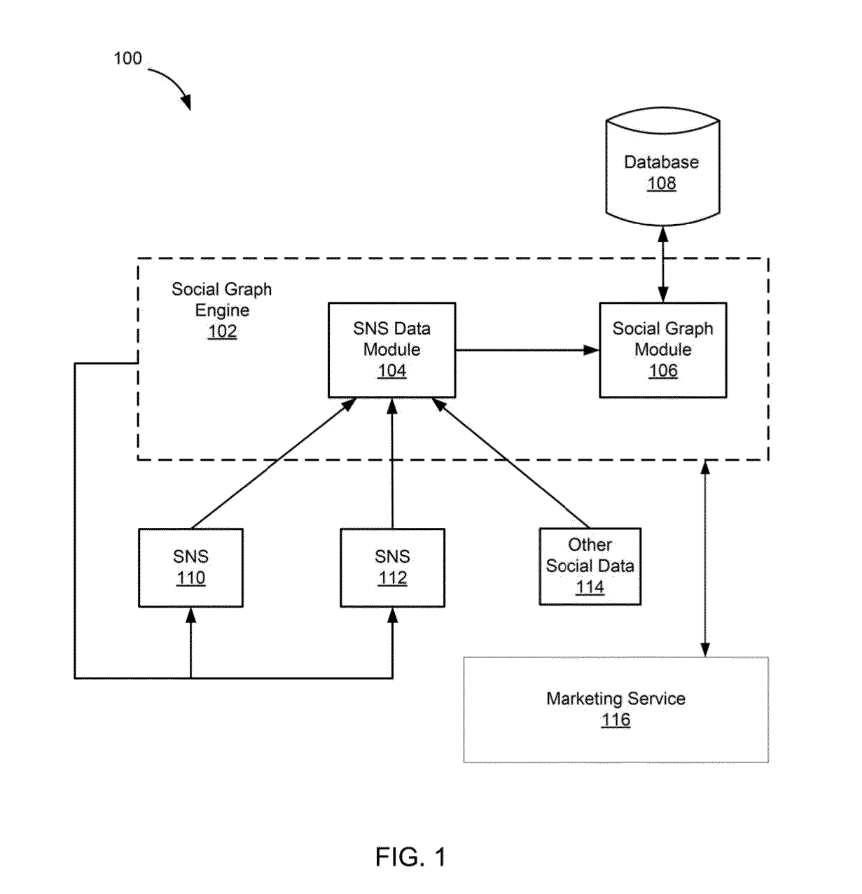

FIG. 1 illustrates an exemplary system for creating, storing and using social graphs for marketing items for sale or rent. System 100 may include social graph engine 102, SNS data module 104, social graph module 106, database 108, SNS 110-112, other social data 114, and marketing service 116. Each or SNS 110-112 may be a social or professional networking service (hereinafter “SNS”) (e.g., Facebook®, Twitter®, Google+®, Linkedln®, etc.). Other social data 114 may include other sources of social marketing or shared personal data, e.g., provided by marketing data services, that may be linked to a personally identifiable information (e.g., name, electronic mail address (hereinafter “e-mail address”), telephone number, drivers license number, other identification number, etc.).

In some examples, social graph engine 102 may be configured to receive an inquiry relating to an item for sale or for rent from a source. For example, the source may be a user of (e.g., a visitor to, a member of, etc.) marketing service 116. The inquiry may include access information (e.g., login associated with an SNS, and in some cases, an option to allow access to personal or social data maintained with the SNS) providing social graph engine 102 access to social data associated with the source of the inquiry. Using the access information, SNS data module 104 may gather social data from SNS 110-112, or from other social data 114. In other examples, SNS data module 104 may gather social data from more or fewer SNS. In still other examples social graph engine 102 may obtain social data through other means (not shown), e.g., manual data input, by tracking a source's browsing behavior, etc. In some examples, this social data may include a list identifying friends of the source, groups to which the source belongs, the source's hometown, the source's current location, the source's educational institution affiliations, the source's work affiliations, and the source's other affiliations. In other examples, the social data may include other information.

In some examples, social graph module 106 may be configured to use the social data gathered by SNS data module 104 to create or update (i.e., include in or add to) a social graph associated with an item for sale or rent. As used herein, a “social graph” refers to a network of connections (e.g., owner(s), buyers, renters (i.e., guests), service providers (e.g., architects, designers, builders, structural engineers, electricians, plumbers, gardeners, handymen, etc.), friends of an owner, friends of a buyer, friends of a renter, friends of friends, etc.) associated with, or attached to, an item. These connections comprise one or more relationships associating a person with the item. For example, a social graph associated with a property for rent may include identifications of such connections as the property owner, past guests, reviewers, service providers, friends of the owner, friends of past guests, friends of friends, etc. By mapping the source's social data, which may include their connections to other people among other shared personal information, to connections associated with an item for sale or rent, the item may be marketed using a trusted and vetted item listing showing how other users known to the source are connected to the item, and hence how the source is connected to the item.

Social graph module 106 may use additional information from different inputs to create or update social graphs. In some examples, information may be entered by the source, or by other users, using forms, fields, menus, widgets, or other input methods on a website. For example, a user may create a listing for an item by identifying the item and adding information about the item, including the user's connection to the item. This listing information may be used by social graph module 106 to create a social graph for the item. The user may invite other users to indicate their connection to the item, and when the other users indicate their connection to the item, social graph module 106 may use that input to update the social graph for the item.

For example, an owner of a vacation rental property may create a listing for the property and indicate her ownership relationship with the property. The owner may input this information through marketing service 116, or through another online listing service for marketing and searching for vacation rental properties (not shown). The owner may input or upload information about the property for rent, including an identification of the property (e.g., address, type (e.g., house, condominium, hotel room, etc.), etc.), a description of the property (e.g., number of bedrooms or bathrooms, number of stories, amenities, accessibility, surrounding features (e.g., beach, lake or river, neighborhood, restaurant/shopping districts, etc.), etc.), pictures of the property, and other information related to the property. In some examples, marketing service 116 may request that the owner create or use a login prior to using the service. Social graph module 106 may use the information related to the property to create a social graph for the property. This social graph may be stored in database 108.

In some examples, social graph module 106 may subsequently update the social graph for the property with additional information and connections entered later by the owner or other users. For example, the owner may have friends that are already users (e.g., members) of marketing service 116, as well as friends that are not members. Marketing service 116 may provide tools for the owner to invite past guests, service providers, friends and other people in her social or professional networks to use marketing service 116 and to indicate their connections to the property. These tools may enable the owner to enter contact information (e.g., e-mail addresses, telephone numbers, etc.) for these people, to which marketing service 116 may then send invitations to visit marketing service 116 and to indicate their connection to the property and/or to the owner. These tools may further enable the owner to track whether the invitations are accepted or not.

In some examples, the invitation may include a link for the recipient to navigate to marketing service 116. In some examples, marketing service 116 may request that the recipient create or use a login prior to using the service. Once logged in, marketing service 116 may connect the recipient to the property by providing the recipient identification and connection information to social graph engine 102. Marketing service 116 also may collect a rating, review, comment, or other input about the property from the recipient. This additional input may be used by social graph module 106 to update the social graph further. In some examples, this additional input may be provided to the owner. In other examples, the owner may designate an administrator, co-owner or property manager, to monitor and update the listing on marketing service 116. The information provided by the administrator also may be used to update the social graph for the listing.

The social graphs created or updated by social graph module I 06 may be stored in database 108. Database 108 may be managed by a database management system (DBMS) (e.g., MySQL®, SQL Server®, Oracle®, etc.). Exemplary representations of, and exemplary schemas for organizing and storing, social graphs are described in more detail below.

In some examples, social graph engine 102 may be configured to provide feedback messages or notifications authorized by, and associated with, the source to SNS 110-112. In an example, social graph engine 102 may output notifications or messages related to the source's connection to an item for which social graphs exist in database 108. The notifications or messages may include photos or pictures of the item, a link to a listing or review (i.e., the source's review) of the item, a personal message from the source associated with the item, or other information associated with the item or the source's connection to the item. The notifications or messages also may be associated with actions by the source associated with the item (e.g., recommending the item, indicating the source likes the item, indicating the source is a fan of the item, commenting on the item, reviewing the item, etc.). For instance, the source may be connected as a friend of an owner of a vacation rental property. A notification or message about this connection may be posted to SNS 110-112 available for the source's friends, acquaintances, professional network, etc., to view (e.g., posted to a Facebook® wall, as a tweet on Twitter®, as LinkedIn® status update, etc.).

In some examples, SNS data module 104 and social graph module 106 may be implemented as part of social graph engine 102. In other examples, one or the other of SNS data module 104 and social graph module 106 may be implemented separately. Database 108 may be implemented separately from social graph engine 102, as shown, or it may be implemented as part of social graph engine 102 (not shown). Different functions and operations beyond those described herein may be performed using system 100. The number, type, function, configuration, or features of system 100 and the above-described elements may be varied and are not limited to the examples provided.

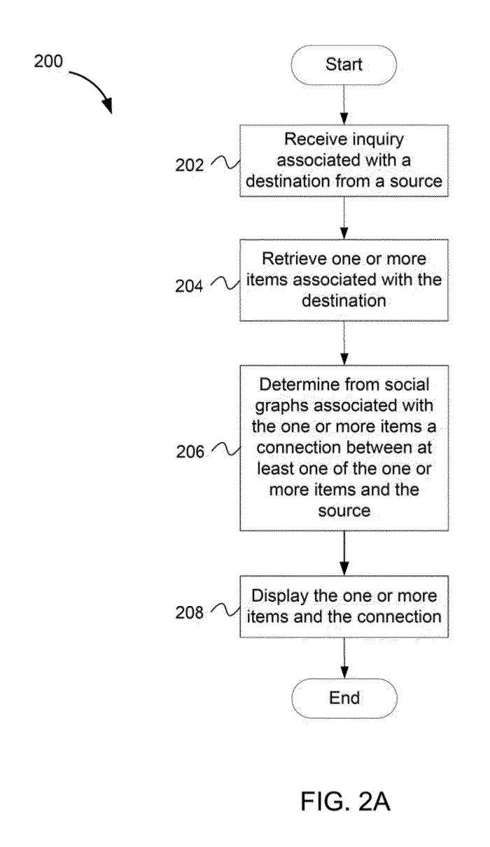

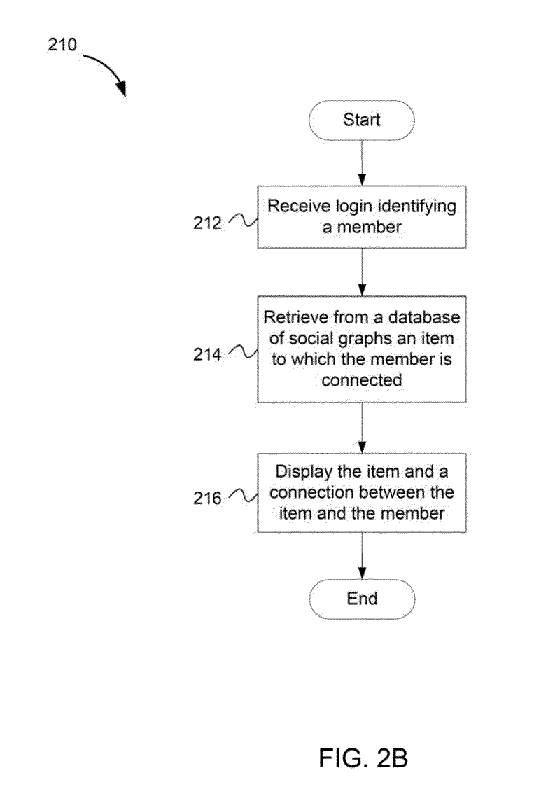

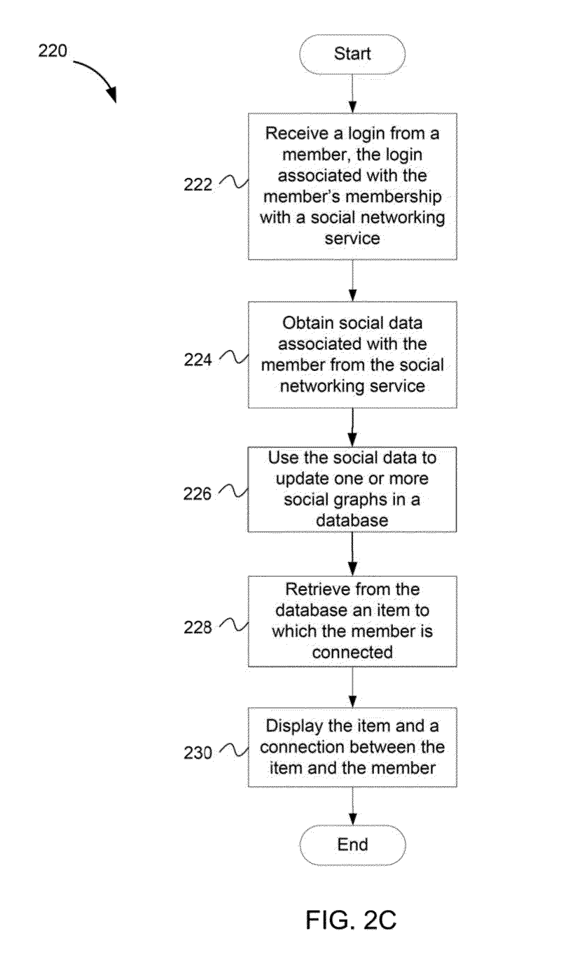

FIGS. 2A-2C illustrate exemplary processes for retrieving and displaying connection information associated with an item using a social graph. In FIG. 2A, process 200 may be implemented as an exemplary process for retrieving and displaying connection information associated with an item in response to an inquiry associated with a destination. In some examples, process 200 may begin with receiving an inquiry associated with a destination from a source (202). The destination may be a vacation or other travel destination, local or remote to the current location of the source. The inquiry may include destination information of varying levels of abstraction (e.g., landmark, city, state, country, region, etc.). In some examples, the inquiry may be made through a vacation rental service or website (e.g., marketing service 116). In some examples, prior to receiving the inquiry, the source may login (using, e.g., a unique username and password, a Facebook® login, a login associated with a different SNS, etc.), or otherwise gain access, to the vacation rental service or website, thereby providing to the service or website information identifying the source. In some examples, the service or website may have stored, or have access to, shared personal data associated with the source. Upon receiving the inquiry, one or more items associated with the destination may be retrieved (204), for example, from database 108 or a different database configured to store items organized by destination. In some examples, each of the one or more items may be vacation rental properties in or around the destination, or listings for the properties. For example, if the inquiry requested vacation rental properties in a town, all vacation rental property listings in that town may be retrieved. In another example, if the inquiry requested vacation rental properties near a landmark (e.g., Grand Canyon, the White House, Lake Michigan, Puget Sound, etc.), all property listings within a designated radius of the landmark may be retrieved. In some examples, this designated radius may be adjusted by the source, or by an administrator of the service or website.

Once the one or more items are retrieved, a determination may be made from social graphs associated with the one or more items a connection between at least one of the one or more items and the source (206). in some examples, the connection may comprise a relationship, or more than one relationship. As described in more detail below, the connection may include an ownership relationship, a past guest relationship, a service provider relationship, a reviewer relationship, a recommender relationship, a friend relationship, or other relationships. For example, a connection may include an ownership relationship, which may indicate the source owns the property. In another example, the connection may include a friend relationship, which may indicate the source is a friend of a member that owns the property. In yet another example, the friend relationship may indicate the source has a friend that is a friend of the owner of the property. After a connection is determined, the one or more items and the connection are displayed (208). In some examples, a plurality of connections may be determined, and the plurality of connections displayed, along with the items associated with the plurality of connections. In some examples, the display of the items may be prioritized in order of relationship proximity (as described in more detail below) between the source and the item. For example, a past guest of a vacation rental property has a closer relationship proximity than a friend of a friend of a past guest. In other examples there may be no connections found between the source and the one or more items associated with the destination, in which case the one or more items may be displayed without any connection information.

In FIG. 2B, process 210 may be implemented as an exemplary process for retrieving and displaying connection information associated with an item in response to a member login. In some examples, process 210 may begin with receiving a login identifying a member (212). The login may be any form of gaining secure access to a vacation rental service or website (e.g., marketing service 116), including a unique username and password, a Facebook® login, a login associated with a different SNS, or other means of secure access. In some examples, once the member is logged in, social or shared personal data associated with the member may be accessed. In other examples, the social or shared personal data associated with the member may already be included in social graphs pertaining to items of interest to the member (e.g., vacation rental properties, listings for properties, other items for rent or sale, etc.). For example, social graphs (e.g., stored in database 108) may include connections associating the member with the items of interest. Once the member is logged in, an item to which the member is connected may be retrieved from the database (e.g., database 108) of social graphs (214). In some examples, the database may comprise a plurality of social graphs indicating a plurality of connections between the member and a plurality of items. The item (or plurality of items) may be displayed, along with the connection (or plurality of connections) associating the member with the item (or plurality of items) (2 16). In some examples, the plurality of items may be displayed in a list. The list may be prioritized in order of relationship proximity between the member and the item.

In FIG. 2C, process 220 may be implemented as an exemplary process for updating social graphs and displaying the updated connection information. In some examples, process 220 may begin with receiving a login from a member, the login associated with the member's membership with a social networking service (222). Examples of social networking services include Facebook®, Twitter®, Google+®, LinkedIn®, as well as other online or mobile social or professional networking services. Once logged in, social data associated with the member may be obtained from the social networking service (224). This social data may include shared personal data or other social data as described in more detail above. The social data may be used to update one or more social graphs in a database (226). In some examples, the social graphs may be updated by social graph module 106 and stored in database 108. Once the database is updated, an item to which the member is connected may be retrieved from the updated database (228). In some examples, the connection between the item and the member may be from an updated social graph. In other examples, a plurality of items to which the member is connected may be retrieved. The item and the connection between the item and the member may he displayed (230). In some examples, the plurality of items may be displayed in a list. The list may be prioritized in order of relationship proximity between the member and the item.

In still other examples, more or fewer of the above-described steps, or different steps, may be carried out to retrieve and display connection information associated with an item.

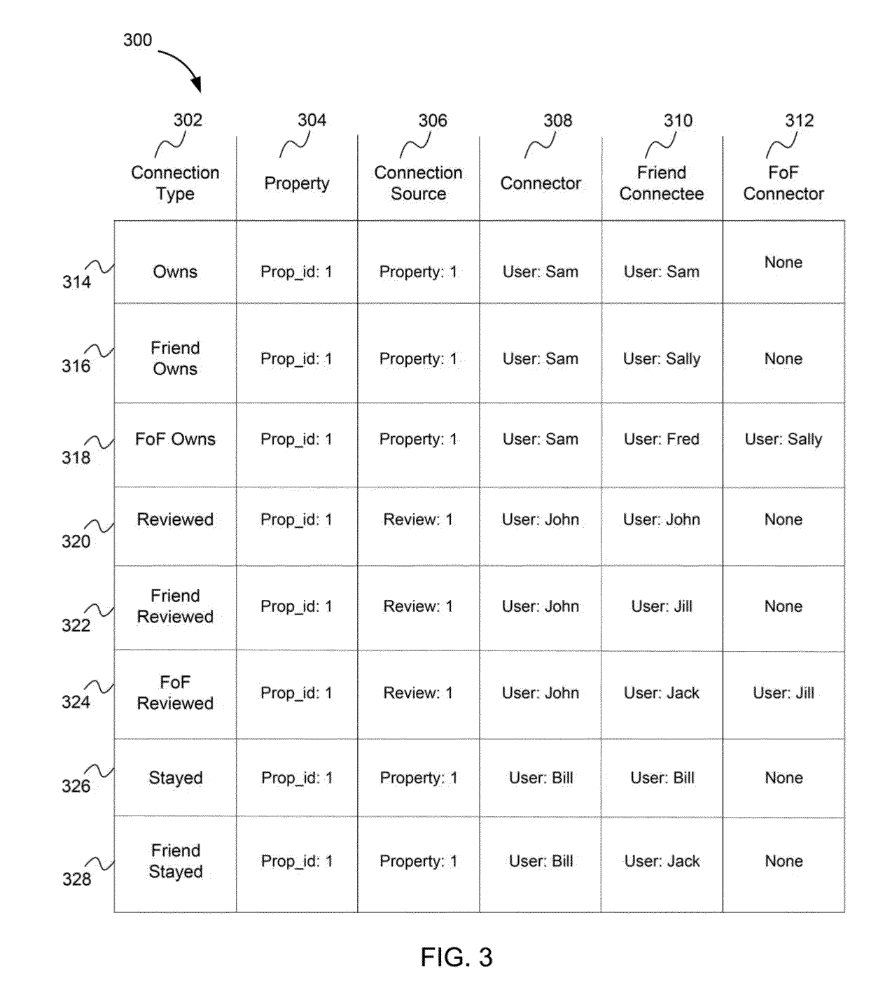

FIG. 3 illustrates an exemplary table for storing connection information in a social graph associated with an item for rent or sale. As shown, table 300 may include the columns Connection Type 302, Property 304, Connection source 306, Connector 308, Friend Connectee 310, and Friend-of-Friend (“FoF”) Connector 312, as well as rows 314-328. Connection type 302 may include the values Owns, Friend Owns, FoF Owns, Reviewed, Friend Reviewed, FoF Reviewed, Stayed and Friend-Stayed. Property 304 may include Prop_id: I, corresponding to the item for rent or sale. Connection source 306 may include Property: 1 and Review: 1, corresponding to the sources of the connection (e.g., a property listing, a review, etc.). Connector 308, friend connectee 310 and FoF connector 312 may include User values (e.g., User: Sam, User: Sally, User: Fred, User: John, User: Jill, User: Jack, User: Bill, etc.), corresponding to members, or a null value (e.g., None). The rows each represent a connection. For example, Row 314 comprises the connection type Owns, the property Prop_id: 1, the connection source Property: 1, the connector User: Sam, friend connectee User: Sam, and no FoF connector. In this example, Row 314 may represent, for the property corresponding to Prop_id: 1, that the user Sam is the owner. Row 316 may represent, for the same property, that the user Sally is a friend of Sam, the owner. Row 318 may represent, for the same property, that user Fred is a friend of Sally, who in turn is a friend of Sam, the owner, and thus Fred is a FoF of the owner. Row 320 may represent, for the same property, that there is a review by user John. Row 322 may represent, for the same property, that Jill is a friend of John, the reviewer. Row 324 may represent, for the same property, that user Jack is a friend of Jill, who in turn is a friend of John, the reviewer, and thus Jack is a FoF of the reviewer. Row 326 may represent, for the same property, that user Bill is a past guest. Row 328 may represent, for the same property, that user Jack is a friend of Bill, the past guest. In other examples, table 300 may be implemented such that a null value may exist in the column friend connectee 310 where the connector has a direct relationship with the property. In still other examples, table 300 may include additional, fewer or different rows indicating additional connections.

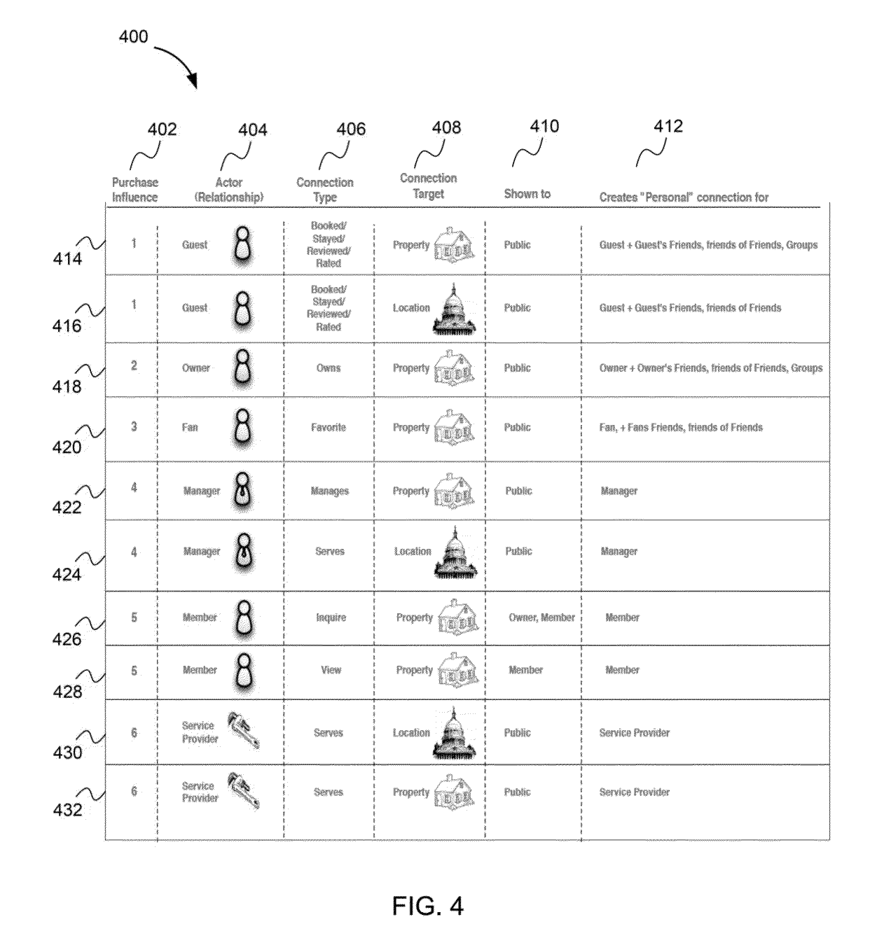

FIG. 4 illustrates an alternative exemplary table for storing connection information in a social graph associated with an item for rent or sale. As shown, table 400 may include the columns Purchase Influence 402, Actor (Relationship) 404, Connection Type 406, Connection Target 408, Shown to 410, Creates “Personal” connection for 412, as well as rows 414-432. In some examples, Purchase Influence 402 may include a numerical value (e.g., numerical values 1-6) corresponding to a weight associated with the likelihood the connection, or type of connection, will influence a subsequent purchase or rental of the item for rent or sale. In some examples, this weighting may reflect a relationship proximity to the connection target (e.g., a property). In some examples, Actor (Relationship) 404 may include values (e.g., guest, owner, fan, manager, member, service provider, etc.) corresponding to how a user has a relationship, or otherwise interacted, with a Connection Target 408. In some examples, Connection Type 406 may include values (e.g., booked, stayed, reviewed, rated, owns, favorite, manages, serves, inquire, view, etc.) corresponding to the type of connection that the actor in that row may have with the connection target in that row. In some examples, Connection Target 408 may include values corresponding to an item of interest (e.g., a property), or group of items of interest (e.g., a location). In some examples, Shown to 410 may include values (e.g., public, owner, member, etc.) corresponding to the sphere of disclosure (e.g., to the public, to only the owner and the member, or to only the member, for example, through marketing service 116) associated with the connection(s) represented in the row. In some examples, Creates “Personal” connection for 412 may include values (e.g., Guest, Guest's Friends, friends of Friends, Groups, etc.) corresponding to the other users for which the connection(s) represented in the row may create a personal connection.

For example, as represented in row 414, a guest that has booked, stayed, reviewed and/or rated a property may have a very strong purchase influence (e.g., value of 1). That guest's connection to the property may be shown to the public, and may create personal connections for the guest, the guest's friends, the guest's FoF, or the guest's groups (e.g., clubs, educational institutions, hobby groups, etc., to which the guest is affiliated). In another example, as represented in row 416, a guest that has booked, stayed, reviewed and/or rated one or more properties in a location may have a very strong purchase influence (e.g., value of 1). The guest's connection to the location may be shown to the public, and may create personal connections for the guest, her friends and her FoF. In another example, as represented in row 418, an owner that owns a property may have a fairly strong purchase influence (e.g., value of 2). The owner's connection to the property may be shown to the public, and may create personal connections for the owner, the owner's friends, the owner's FoF, and the owner's groups. In another example, as represented in row 420, a fan that has indicated a property as her favorite may have an above average purchase influence (e.g., value of 3). The fan's connection to the property may be shown to the public, and may create personal connections for the fan, the fan's friends, and the fan's FoF. In another example, as represented in row 422, a manager that manages a property may have a relatively average purchase influence (e.g., value of 4). The manager's connection to the property may be shown to the public, and may create a personal connection for the manager. In another example, as represented in row 424, a manager that manages one or more properties in a location may have a relatively average purchase influence (e.g., value of 4). The manager's connection to the location may be shown to the public, and may create a personal connection for the manager. In another example, as represented in row 426, a member that inquires about a property may have a below average purchase influence (e.g., value of 5). The member's inquiry regarding the property may be shown to the owner and the member, and may create a personal connection for the member. In another example, as represented in row 428, a member that views a property may have a below average purchase influence (e.g. value of 5). The member's viewing of the property may be shown to only the member, and may create a personal connection for the member. In another example, as represented by row 430, a service provider that serves one or more properties in a location may have a low purchase influence (e.g., value of 6). The service provider's connection to the location may he shown to the public, and may create a personal connection for the service provider, or other service providers. In another example, as represented by row 432, a service provider that serves a property may have a low purchase influence (e.g., value of 6). The service provider's connection to the property may be shown to the public, and may create a personal connection for the service provider, or other service providers. In other examples, the guest, owner, fan, manager, member, or service provider, may create personal connections for other users in their network not shown in table 400. For example, a manager's connection to a property or a location may create personal connections for the manager's friends or FoF. In other examples, a service provider's connection to a property or a location may create personal connections for the service provider's friends or FoF. In still other examples, table 400 may include additional, fewer or different rows and columns.

The above-described tables show examples of how data associated with user's connections with properties may be stored and organized. In still other examples, tables may be created to store and organize other data associated with social graphs. For example, a table may store data associated with a member's total friends, including friends that are members and friends that are not members. In another example, a table may store data associated with how members are related to other members, including whether they are friends (e.g., Facebook® friends, etc.) or FoFs (e.g., connected through a mutual friend). In another example, a table may store data associated with the relationship and associated privileges that an owner, administrator, co-owner, or property manager, may have for a property.

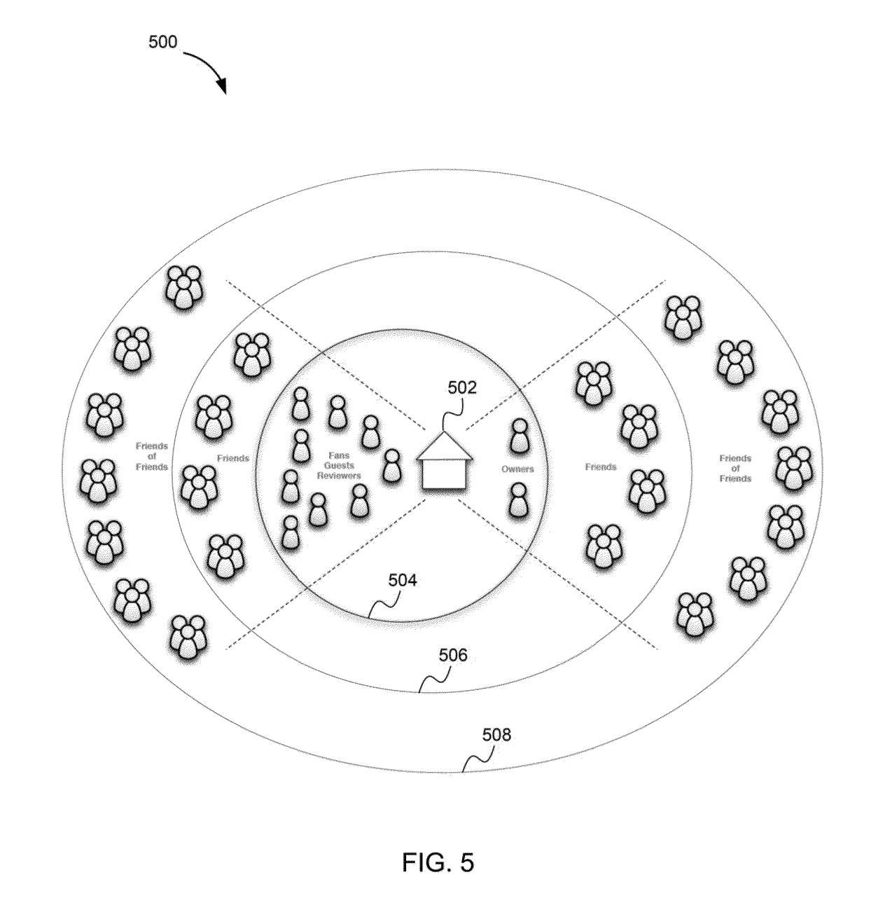

FIG. 5 illustrates an exemplary representation of a social graph for an item for rent or sale. Social graph 500 may include item 502, inner group 504, middle group 506 and outer group 508. In some examples, item 502 may be an item of interest to a potential renter or buyer. For example, item 502 may be a vacation rental property. In some examples, inner group 502 may represent or include the closest, and thus most powerful, connections to item 502. These connections may exert the most purchase influence on the users. For example, inner group 502 may include owners, fans, guests and reviewers. In some examples, middle group 506 may represent or include the next closest, and still powerful, connections to item 502. These connections may exert an average or medium purchase influence on the users. For example, middle group 506 may include users with friend relationships with item 502 (e.g., friend of owner, friend of guest, friend of reviewer, friend of fan). In some examples, outer group 508 may represent or include more tenuous, but existing, connections to item 502. These connections still may exert some purchase influence on the users.

In some examples, inner group 502, middle group 506, and outer group 508, each may represent a relationship proximity to item 502. This relationship proximity may be used to assign a weight to the connections in each group. The weight may be used to prioritize displays of the connections, for example, through marketing service 116. In other examples, relationship proximity may be defined differently, and thus weights assigned to connections differently (not shown). For example, a first group with the closest relationship proximity to item 502 may include a member that owns, manages or listed item 502, a member that rated item 502, a member that is a past guest of item 502, a member that left a comment about item 502, and a member that indicated a liking for (i.e., “liked”) item 502. In this example, a second group with the next closest relationship proximity to item 502 may include a friend of a past guest of item 502, a friend of a member that rated item 502, a friend of a member that left a comment about item 502, and a friend of a member that liked item 502. In this example, a third group with the third closest relationship proximity to item 502 may include a friend of an owner of item 502, a friend of a manager of item 502, and a friend of an owner of item 502. In this example, a fourth group with the fourth closest relationship proximity to item 502 may include a FoF of a past guest of item 502, a FoF of a member that rated item 502, and a FoF of a member that left a comment about item 502. The first group has the greatest weight, thus the connections therein may be prioritized first when being displayed for other members viewing item 502 or browsing the loction of item 502, for example, through marketing service 116. The second group has the second greatest weight, and thus the connections in the second group may have secondary priority when being displayed for other members, and so on with the remaining groups. Any of the above-described groupings, or any other type of groupings based upon connections in a social graph, may be used in promotions associated with an item (e.g., item 502). For example, an owner, co-owner, or property manager, may offer a certain discount to all members in a group for renting item 502. In another example, an owner, co-owner, or property manager, may offer a different or additional discount to all members in a group that refer their friends. Many different types of promotions and incentives associated with item 502 may be offered based on the data in social graphs.

In other examples, displays of different items of interest may also be prioritized based on weights assigned according to the quality of the listing for the item (not shown). The quality of the listing may be determined by a number of factors associated with the completeness of the listing, including the number of connections associated with the listing, the number and quality of photos associated with the listing, the number of recommendations, reviews, fans, comments, likes, etc., associated with the listing. In other examples, social graph 500 may be represented using a different graphic, with additional or fewer groups or members of groups.

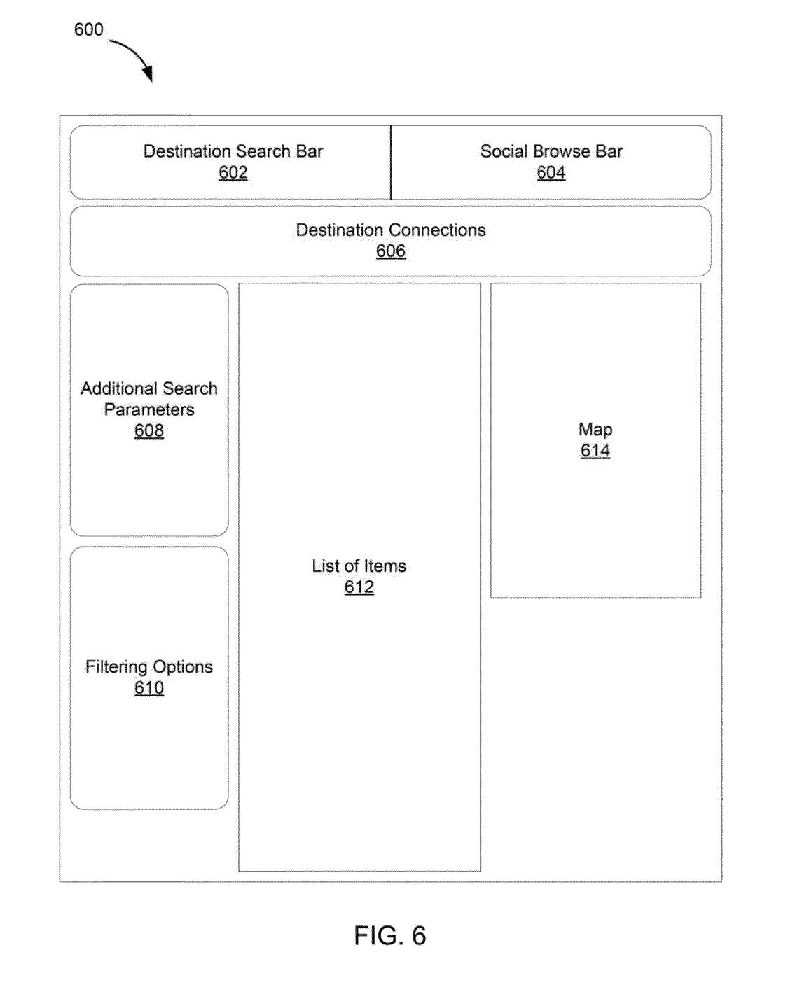

FIG. 6 illustrates an exemplary wireframe of an exemplary marketing webpage providing search and display capabilities associated with a database of social graphs. Here, wireframe 600 comprises destination search bar 602, social browse bar 604, destination connections 606, additional search parameters 608, filtering options 610, list of items 612, and map 614. An exemplary webpage may include fewer or more features further providing search and display capabilities associated with a database of social graphs. In some examples, destination search bar 602 may include a field for inputting a destination. In some examples, destination search bar 602 may be configured to accept destination inputs of varying levels of abstraction, including addresses, landmarks, cities, states, countries, regions, building names, and others.

In some examples, social browse bar 604 may display a member's personal connections. The member's personal connections may be included in social graphs, as described herein. For example, social browse bar 604 may display all of the member's personal connections. In another example, social browse bar 604 may display a subset of the member's personal connections (e.g., the personal connections that were recently active on the website, the most proximate personal connections (e.g., friends, as opposed to FoF), the personal connections residing within a certain radius of the member's current location, etc.). This display may take various forms, including a picture, a name, an avatar, or other representation of each personal connection. In some examples, the display of personal connections may be configured to enable a member to click on a personal connection to navigate to a webpage that shows all items to which the member is connected via the personal connection. In other examples, social browse bar 604 also may include a button, icon or link for navigating to another webpage for browsing all items associated with the member through the member's personal connections.

In some examples, destination connections 606 may display a member's personal connections with attachments to, or connections with, items in a particular destination. For example, if a member inquires about items associated with a destination (e.g., a city, state, address; landmark, country, region, building name, etc.), destination connections 606 may display (e.g., as a list, a series of buttons, icons, pictures, avatars and/or names, etc.) the personal connections that correspond to the resulting list of items 612. In this example, list of items 612 may display the results of a member's inquiry about items associated with a destination. In this example, map 614 may display a map of the destination. In other examples, a default list of items 612 may be displayed, along with corresponding connections in destination connections 606. For example, the default list of items 612 may include vacation rental properties located within a designated radius of the member's current location. In this example, map 614 may display a map of the member's current location or other default location. In some examples, list of items 612 may include representations of various types of information associated with the item. For example, if the item is a vacation rental property, list of items 612 may comprise a series of abbreviated listings for properties. These listings may include a title, a picture, a brief description (including information associated with, e.g., location, size, number of bedrooms, number of bathrooms, capacity, etc.), a standard rate, a link to reviews, a representation of a reviewer (e.g., picture, avatar, name, etc.), a rating or summary rating, an identification of an owner, co-owner, property manager, listing agent or listing administrator. In some examples, the abbreviated listings displayed in list of items 612 may include a link to the full listing. In other examples, the abbreviated listings displayed in list of items 612 may include more or fewer items of information than described herein.

In some examples, additional search parameters 608 may include forms, fields, pull-down menus, or other methods for data entry, associated with criteria for focusing or narrowing the member's search. For example, where the member is searching for vacation rental properties, such criteria may include a check-in date, a check-out date, a type of offer (e.g., rent, trade, sell, etc.), a type of property (e.g., apartment, condominium unit, house, duplex, etc.), a capacity (e.g., number of people the property sleeps), a bedroom count, a maximum price, a minimum price, and so on. In other examples, additional search parameters 608 may provide for entry of more, fewer or different types of data. In still other examples, additional search parameters 608 may include a link, icon or button that enables the member to navigate to another webpage, or to open up an additional element or window, that provides further search options.

In some examples, filtering options 610 may include forms, fields, pull-down menus, or other methods for data entry, associated with criteria for focusing or narrowing the results displayed in list of items 612. For example, filtering options 610 may include options for showing only items to which the member is connected through a past guest, an owner, a commenter, a fan, a friend, and/or a FoF. In other examples, filtering options 610 may provide for selection of more, fewer or different criteria.

In some examples, wireframe 600 may further comprise one or more navigation bars, icons or buttons (not shown) for. navigating (e.g., linking) to other associated webpages, for example a homepage (e.g., a personalized homepage for a member or other homepage), a sign-in or login page, a page for creating a new listing for an item, an information page about how the website or web service, other information pages, a support page, a page answering frequently asked questions (FAQ), a sign-out or logout page, a page showing all items available for viewing, or other pages.

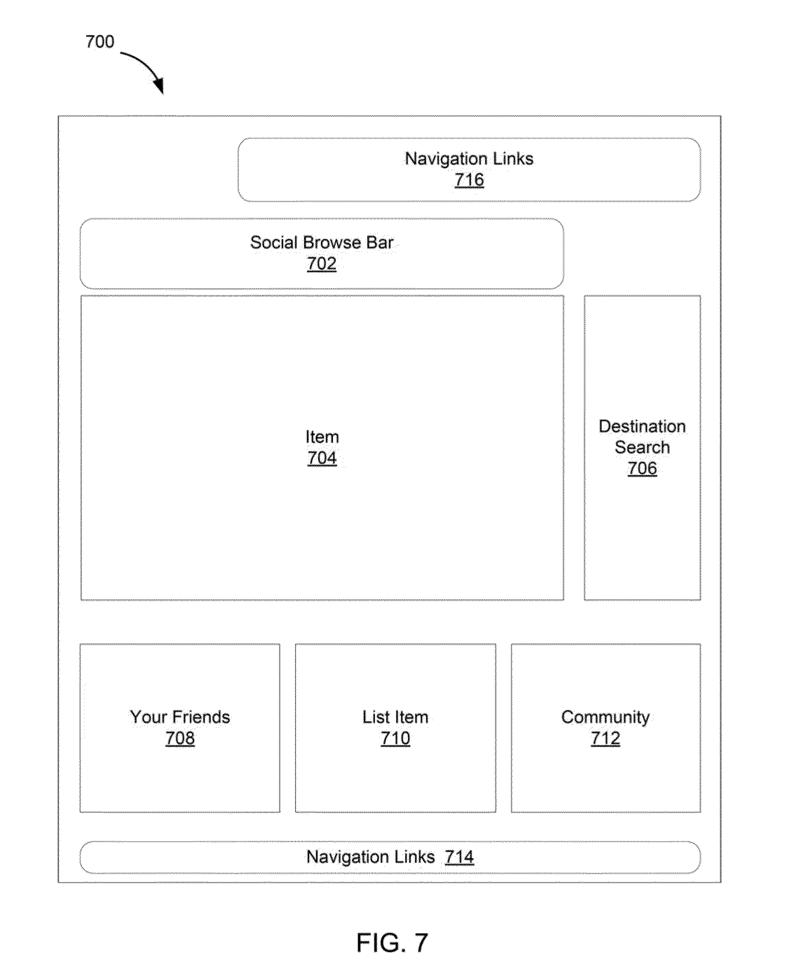

FIG. 7 illustrates an alternative exemplary wireframe of an exemplary marketing webpage providing search and display capabilities associated with a database of social graphs. Here, wireframe 700 comprises social browse bar 702, item 704, destination search 706, your friends 708, list item 710, community 712, and navigation links 714-716. An exemplary webpage may include fewer or more features further providing search and display capabilities associated with a database of social graphs. In some examples, social browse bar 702 may display a member's personal connections, or a subset of the member's personal connections. The member's personal connections may be included in social graphs, as described herein. Social browse bar 702 may be configured in a similar manner, and include similar features, as described above regarding social browse bar 604.

In some example, item 704 may include a picture, a listing, an abbreviated listing, or other identifying information or representation associated with an item to which a member is connected. In some examples, the webpage may include a call-out or other notification (not shown) providing additional information about item 704, including how the member may be connected to item 704.

In some examples, destination search 706 may include a field, or other data entry method (e.g., pull-down menus, forms, etc.), for inputting a destination. Destination search 706 may be configured in a similar manner, and include similar features, as described above regarding destination search bar 602. In some examples, your friend 708 may display the member's personal connections. Your friends 708 may be implemented in a similar manner, and include similar features, as described above regarding social browse bar 702 and social browse bar 604.

In some examples, list item 710 may provide a button, icon or link to a webpage, application or widget enabling a member to create a listing for an item. In some examples, list item 710 also may include a brief description of the feature for creating a listing for an item. In some examples, list item 710 also may include a representative picture.

In some examples, community 712 may provide a button, icon or link to a webpage, application or widget enabling a member to build her community of personal connections. In some examples, community 712 also may include a brief description of the feature for building a community. In some examples, community 712 may include a representative picture.

In some examples, navigation links 714-716 may include buttons, icons or links for navigating (e.g., linking) to other associated webpages. In some examples, these associated webpages may include a homepage, a sign-in or login page, a page for creating a new listing for an item, an information page about how the website or web service, other information pages, a support page, a page answering frequently asked questions (FAQ), a sign-out or logout page, a page showing all items available for viewing, or other pages.

In other examples, other types of webpages may be implemented to provide search and display capabilities associated with a database of social graphs. For example, a webpage may be implemented providing owners, co-owners, property managers, listing agents, or listing administrators, with privileges for managing listings of items (e.g., edit listings, build a guest book around a property listing, etc.). In another example, a webpage may be implemented providing detailed listings of items. In yet another example, a webpage may be implemented enabling a member to build and manage their circles of friends or relationships (e.g., a social circle). In still other examples, webpages providing search, display and other capabilities associated with a database of social graphs may be implemented differently than described herein.

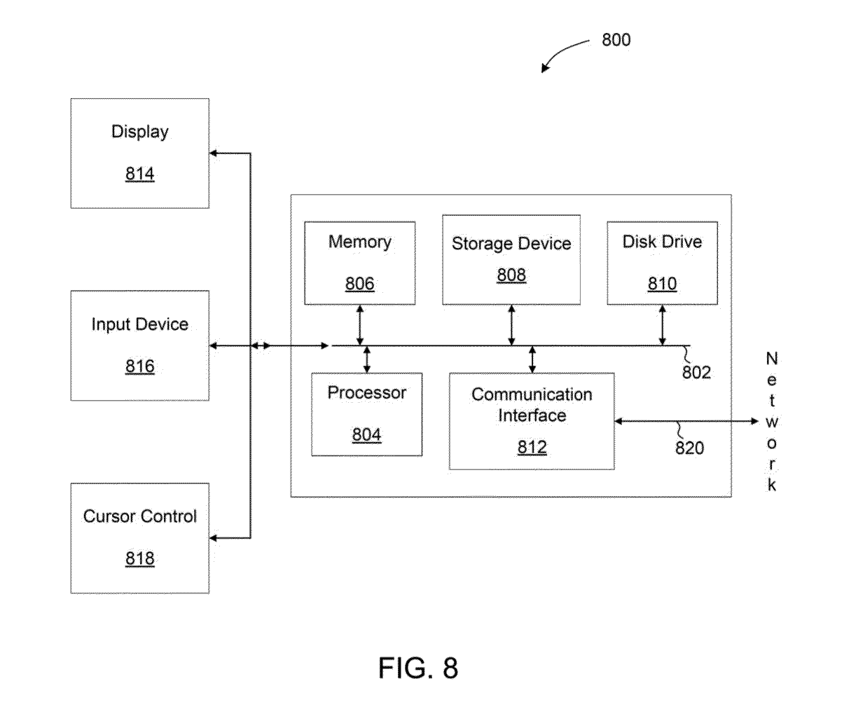

FIG. 8 illustrates an exemplary computer system suitable for creating, storing and using social graphs for marketing items for rent or sale. In some examples, computer system 800 may be used to implement computer programs, applications, methods, processes, or other software to perform the above-described techniques. Computer system 800 includes a bus 802 or other communication mechanism for communicating information, which interconnects subsystems and devices, such as processor 804, system memory 806 (e.g., RAM), storage device 808 (e.g., ROM), disk drive 810 (e.g., magnetic or optical), communication interface 812 (e.g., modem or Ethernet card), display 814 (e.g., CRT, LED, LCD, plasma, OLED, etc.), input device 816 (e.g., keyboard), and cursor control 818 (e.g., mouse or trackball).

According to some examples, computer system 800 performs specific operations by processor 804 executing one or more sequences of one or more instructions stored in system memory 806. Such instructions may be read into system memory 806 from another computer readable medium, such as static storage device 808 or disk drive 810. In some examples, hard-wired circuitry may be used in place of or in combination with software instructions for implementation.

The term “computer readable medium” refers to any tangible medium that participates in providing instructions to processor 804 for execution. Such a medium may take many forms, including but not limited to, non-volatile media and volatile media. Non-volatile media includes, for example, optical or magnetic disks, such as disk drive 810. Volatile media includes dynamic memory, such as system memory 806.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM; PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 702 for transmitting a computer data signal.

In some examples, execution of the sequences of instructions may be performed by a single computer system 800. According to some examples, two or more computer systems 800 coupled by communication link 820 (e.g., LAN, PSTN, or wireless network) may perform the sequence of instructions in coordination with one another. Computer system 800 may transmit and receive messages, data, and instructions, including program, i.e., application code, through communication link 820 and communication interface 812. Received program code may be executed by processor 804 as it is received, and/or stored in disk drive 810, or other non-volatile storage for later execution.

Although the foregoing examples have been described in some detail for purposes of clarity of understanding, the invention is not limited to the details provided. There are many alternative ways of implementing the invention. The disclosed examples are illustrative and not restrictive.

1.-10. (canceled)

11. A method, comprising:
receiving a login identifying a member;
retrieving from a database an item to which the member is connected; and
displaying the item and a connection between the item and the member,

12. The method of claim 11, wherein the database comprises a social graph associated with the item, the social graph comprising the connection.

13. The method of claim 11, wherein the login comprises an electronic mail address and a password.

14. The method of claim 11, wherein the login is associated with the member's membership with a social networking service.

15. The method of claim 14, further comprising:
obtaining social data associated with the member from the social networking service; and
using the social data to update one or more social graphs in the database.

16. The method of claim 15, wherein the social data comprises a list of the member's friends.

17. The method of claim 15, wherein the social data comprises a demographic associated with the member.

18. The method of claim 15, wherein the social data comprises a group affiliated with the member,

19. A computer readable medium including instructions for performing a method, the method comprising:
receiving a login identifying a member;
retrieving from a database an item to which the member is connected; and
displaying the item and a connection between the item and the member.
